(19) United States
(12) Patent Application Publication
(10) Pub. No.: US 2023/0164258 A1
(43) Pub. Date: May 25, 2023

(54) Mobile Phone Stand

(71) Applicant: Daniel Chen Bowman, Minneapolis, MN (US)

(72) Inventor: Daniel Chen Bowman, Minneapolis, MN (US)

(21) Appl. No.: 18/151,421

(22) Filed: Jan. 7, 2023

Related U.S. Application Data
(63) Continuation-in-part of application No. 16/786,676, filed on Feb. 10, 2020, now abandoned.

(51) Int. Cl. H04M 1/04

(52) U.S. Cl. CPC H04M 1/04

(57) ABSTRACT

An article of manufacture for providing an adjustable mobile phone stand according to the present invention is disclosed. The adjustable mobile phone stand includes a rear plate member having a first inner surface a first end and a second end, and a first pair of support arm channels, a front plate member having a second inner surface, a first end and a second end, and a second pair of support arm channels, a pair of extendable support arms coupled between the rear plate member and the front plate member, a set of hinge pins, a set of hinge channels in which the set of hinge pins pass through the first end and a second end of the rear plate member and the front plate member, and a base plate member. The pair of extendable support arms each have a first end and a second end.

### CROSS-REFERENCE TO RELATED APPLICATION

This application claims priority to U.S. patent application Ser. No. 16/786,676, titled “Digital Device Accessory and Stand,” and filed on Feb. 10, 2020. The entire application is incorporated herein by reference in its entirety

### TECHNICAL FIELD

This application relates in general to an article of manufacture for providing a mobile phone accessory, and more specifically, to an article of manufacture providing an adjustable mobile phone stand.

### BACKGROUND

Current mobile device accessories lack the design and functionality to meet widespread consumer demand. HAND5TAND's multifunctional grip handle provides the ability to be used for ergonomic device viewing at varying degrees and accessibility that improves the interaction between user and device. It is scalable and has a flat non-protruding profile.

Therefore, a need exists for an article of manufacture for providing an adjustable mobile phone stand. The present invention attempts to address the limitations and deficiencies in prior solutions according to the principles and example embodiments disclosed herein.

### SUMMARY

In accordance with the present invention, the above and other problems are solved by providing an article of manufacture for an adjustable mobile phone stand according to the principles and example embodiments disclosed herein.

In one embodiment, the present invention is an article of manufacture for providing an adjustable mobile phone stand. The adjustable mobile phone stand includes a rear plate member having a first inner surface a first end and a second end, and a first pair of support arm channels, a front plate member having a second inner surface, a first end and a second end, and a second pair of support arm channels, a pair of extendable support arms coupled between the rear plate member and the front plate member, a set of hinge pins, a set of hinge channels in which the set of hinge pins pass through the first end and a second end of the rear plate member and the front plate member, and a base plate member. The pair of extendable support arms each have a first end and a second end.

In another aspect of the present invention, each of the hinge pin within the set of hinge pins is positioned within one of the hinge channels of the set of hinge channels with opposing ends of the set of hinge pins coupling within one of the pair of support arm channels to couple the rear plate member to the front plate member.

In another aspect of the present invention, the first end and the second end of the pair of extendable support arms are coupled within the pair of support arm channels about a set of release holes through the rear plate member and the front plate member.

In another aspect of the present invention, the rear plate member and the front plate member are sized to fit within the rear surface of a mobile phone, the base plate member couples between a rear surface of the rear plate member and the mobile phone, and the base plate member couples to the phone stand rear plate member with adhesive.

In another aspect of the present invention, the adhesive is part of double sided tape having the wax paper that may be removed from a first side one of the double sided tape to expose the adhesive and then a second side of the double sided tape is pressed onto the base plate member.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture providing an adjustable mobile phone stand attached to a phone according to the present invention.

FIG. 2 illustrates an exploded view of the components within an article of manufacture providing an adjustable mobile phone stand according to the present invention.

FIGS. 3a-b illustrate release bottoms for opening an article of manufacture providing an adjustable mobile phone stand according to the present invention.

FIGS. 4a-e illustrate various views of an article of manufacture providing an adjustable mobile phone stand according to the present invention.

FIGS. 5a-c illustrate various views of an article of manufacture providing an adjustable mobile phone stand in an open orientation according to the present invention.

### DETAILED DESCRIPTION

This application relates in general to an article of manufacture for providing a mobile phone accessory, and more specifically, to an article of manufacture providing an adjustable mobile phone stand according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using an article of manufacture providing an adjustable mobile phone stand according to the present invention. The term user herein refers to one or more users.

The term “invention” or “present invention” refers to the invention being applied for via the patent application with the title “Mobile Phone Stand.” Invention may be used interchangeably with stand.

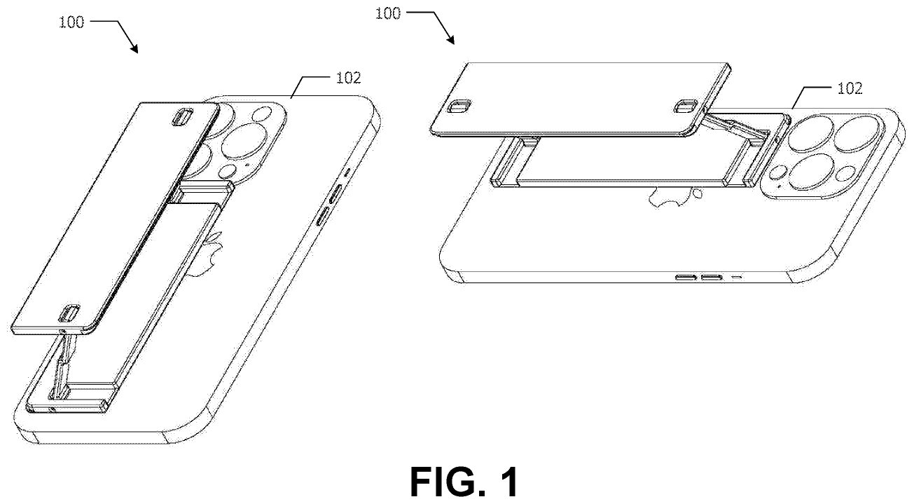

In general, the present disclosure relates to an article of manufacture providing an adjustable mobile phone stand according to the present invention. To better understand the present invention, FIG. 1 illustrates an example embodiment of an article of manufacture providing an adjustable mobile phone stand attached to a phone according to the present invention. An adjustable phone stand 100 is shown in FIG. 1 attached to a back surface of a mobile phone 102. adjustable phone stand 100 is currently made out of 70/75 aluminum and Delrin. The aluminum can be anodized for color and laser etched for design purposes. The Delrin can also be laser etched for design purposes. We are also seeking other processes with seracoat and sublimation. Designs can be customizable to customer preference and will be created by community artists.

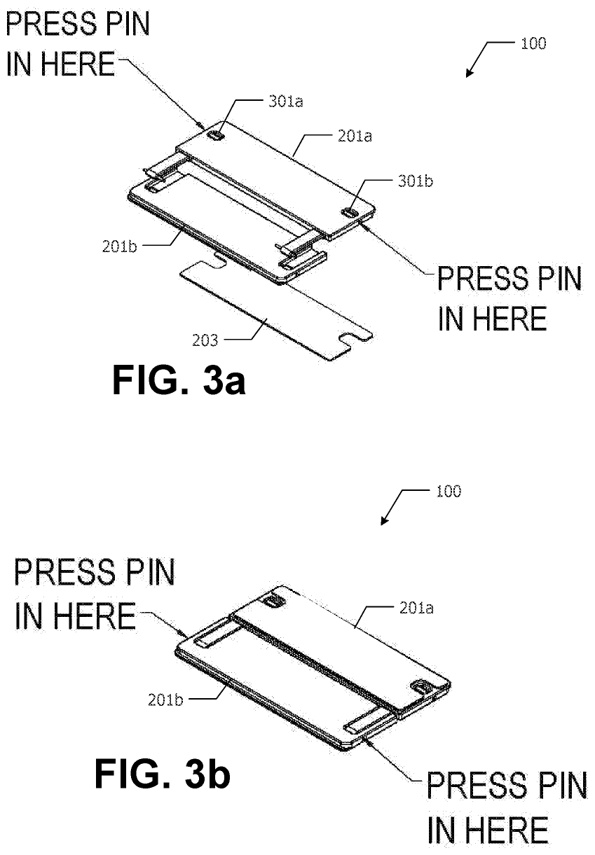

The adjustable phone stand 100 comprises a pair of support plate members 201a-b that is coupled to each other by a pair of extendable support arms 202a-b. The pair of support plate members 201a-b may be moved from an open or extended configuration, as shown in FIG. 1, and a closed or retracted configuration, as shown in FIG. 3b.

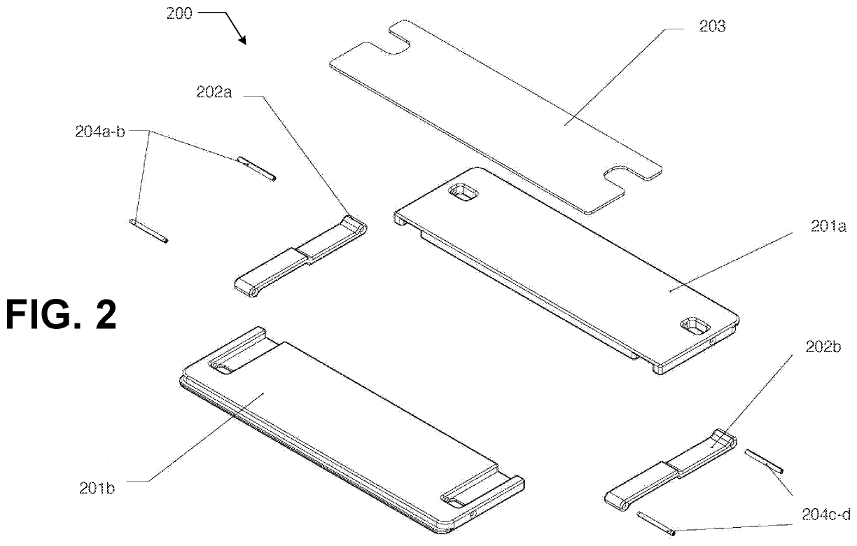

FIG. 2 illustrates an exploded view of the components within an article of manufacture providing an adjustable mobile phone stand according to the present invention. The adjustable phone stand 100 comprises a rear plate member 201a, a front plate member 201b, a pair of extendable support arms 202a-b, a set of hinge pins 204a-d, and a base plate member 203. The rear plate member 101a and the front plate member 101b each having an inner surface 211a-b and a pair of support arm channels 212a-d. The pair of extendable support arms 202a-b each has a first end and a second end 212a-d. A hinge channel of a set of hinge pins 213a-d pass through the first end and a second end 212a-d of the rear plate member 101a and the front plate member 101b.

Each of the hinge pin within the set of hinge pins 204a-d is positioned within one of the hinge channels of the set of hinge channels 213a-d with opposing ends of the set of hinge pins 204a-d coupling within one of the pair of support arm channels 212a-d to couple the rear plate member 201a to the front plate member 201b. The first end and the second end 212a-d of the pair of extendable support arms 202a-b are coupled within the pair of support arm channels 212a-d about a set of release holes 301a-d through the rear plate member 101a and the front plate member 101b.

The rear plate member 201a and the front plate member 201b are sized to fit within the rear surface of the mobile phone 102. The base plate member 203 couples between a rear surface of the rear plate member 201a and the mobile phone 102. The base plate member 203 couples to the phone stand rear plate member 201a with adhesive. The double sided tape 203 has the wax paper removed from side one of the double sided tape 203 to expose the adhesive and then side one of the double sided tape 203 is pressed onto the base plate member 201a. Now that the double sided tape 203 has been installed onto the phone stand 100, the next step would be to apply the phone stand 100 to the mobile phone rear surface 102. To apply the phone stand 100 to the rear phone surface 102, the wax paper is removed from side two of the of the double sided tape 203 and then side two of the double sided tape 203 is pressed onto the rear phone surface 102.

FIGS. 3a-b illustrate release bottoms for opening an article of manufacture providing an adjustable mobile phone stand according to the present invention. FIG. 3a shows the rear plate member 201a and the pair of extendable support arms 202a-b coupled together and positioned above the front plate member 201b. A pair of the set of hinge pins 204a-d is positioned within the exposed hinge channels of the set of hinge channels 213a-d. When the adjustable phone stand 100 is configured, the pair of the set of hinge pins 204a-dengage the hinge channels of the set of hinge channels 213a-d on the front plate member 201b. The base plate member 203 is shown below the front plate member 201b.

One of the set of hinge holes 301a-d is located at an inner end of each of the set of hinge channels 213a-d with one of the set of hinge pins 204a-d coupling one end of the pair of extendable support arms 202a-b to the pair of front and rear plate member 201a-b. The set of hinge holes 301a-d is configured to permit the pair of extendable support arms 202a-b to rotate about the set of hinge pins 204a-d.

FIG. 3b shows the adjustable phone stand 100 when the pair of extendable support arms 202a-b is coupled within the set of hinge holes 301a-d. The adjustable phone stand 100 is shown in FIG. 3b in the closed or retracted configuration.

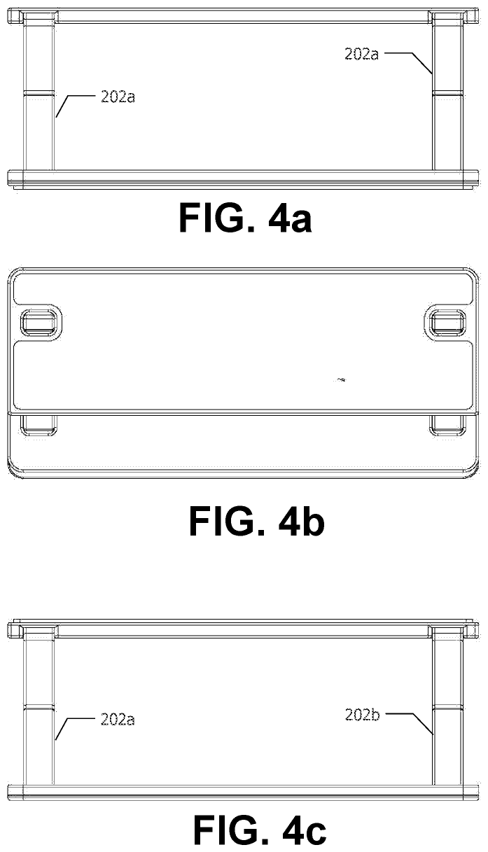

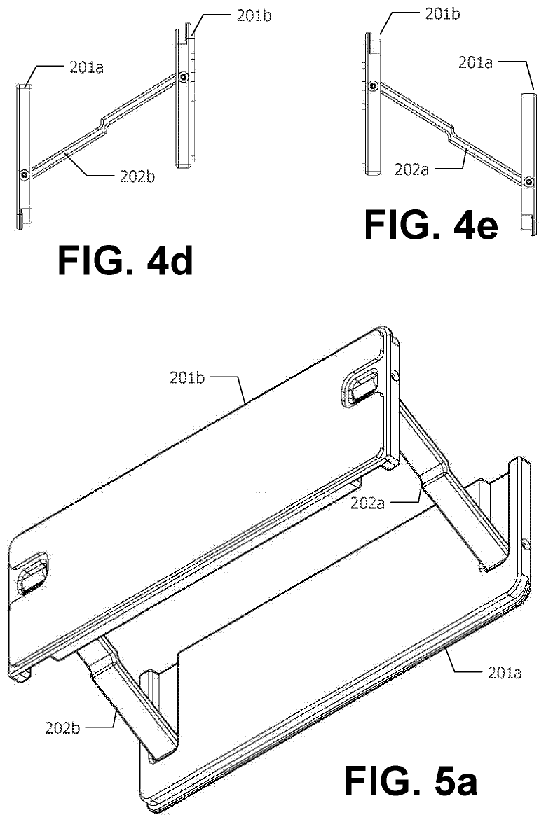

FIGS. 4a-e illustrate various views of an article of manufacture providing an adjustable mobile phone stand in the open configuration according to the present invention. FIG. 4a shows a front view of the adjustable phone stand 100 in the open configuration. The pair of extendable support arms 202a-b is shown coupling the rear plate member 201a to the front plate member 201b. The opposing ends of the pair of extendable support arms 202a-b engage its corresponding pair of front and rear plate members 201a-b in the set of hinge holes 301a-d. An anti-rotation features may be added into the phone stand 100 by the use of friction. Spring pins 204a-d create friction on the arm holes 213a-d and plate holes preventing the arms from rotating freely. The spring pins 204a-d expand into the arm holes 213a-d and plate holes and create a friction on the circumference of the holes preventing the arms and plates from rotating freely. The movement of the phone stand 100 must come from an applied force (i.e. a user has to forcefully move the phone stand) to change the position of the phone stand 100.

FIG. 4b shows a top view of the adjustable phone stand 100. The opposing ends of the pair of extendable support arms 202a-b are shown within one of the corresponding pair of front and rear plate members 201a-b in the set of hinge holes 301a-d. FIG. 4c shows a rear view of the adjustable phone stand 100 in the open configuration that is similar to the view of FIG. 4a.

FIGS. 4d and 4e show opposing sides of the adjustable phone stand 100 with the pair of extendable support arms 202a-b coupling the rear plate member 201a to the front plate member 201b.

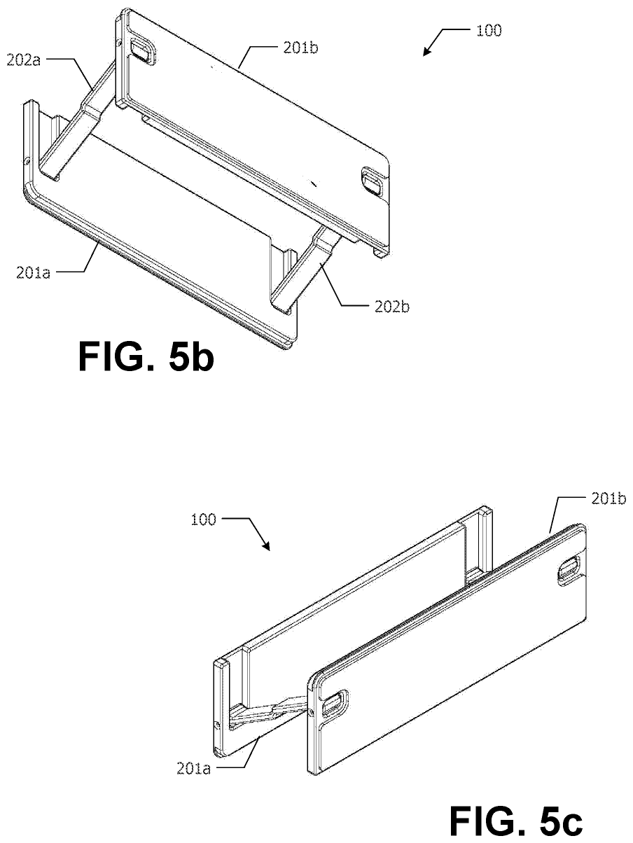

FIGS. 5a-c illustrate various views of an article of manufacture providing an adjustable mobile phone stand in an open orientation according to the present invention. Perspective views of the adjustable phone stand 100 are shown in each of the FIGS. 5a-c. The adjustable phone stand 100 is shown in the open configuration in each of the FIGS. 5a-c.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing an adjustable mobile phone stand, the adjustable mobile phone stand comprises:
a rear plate member having a first inner surface, a first end and a second end, and a first pair of support arm channels;
a front plate member having a second inner surface, a first end and a second end, and a second pair of support arm channels;
a pair of extendable support arms coupled between the rear plate member and the front plate member, the pair of extendable support arms each having a first end and a second end;
a set of hinge pins;
a set of hinge channels in which the set of hinge pins pass through the first end and a second end of the rear plate member and the front plate member; and
a base plate member.

2. The adjustable mobile phone stand according to claim 1, wherein each of the hinge pin within the set of hinge pins is positioned within one of the hinge channels of the set of hinge channels with opposing ends of the set of hinge pins coupling within one of the pair of support arm channels to couple the rear plate member to the front plate member.

3. The adjustable mobile phone stand according to claim 2, wherein the first end and the second end of the pair of extendable support arms are coupled within the pair of support arm channels about a set of release holes through the rear plate member and the front plate member.

4. The adjustable mobile phone stand according to claim 2, the rear plate member and the front plate member are sized to fit within the rear surface of a mobile phone; and
the base plate member couples between a rear surface of the rear plate member and the mobile phone,
and the base plate member couples to the phone stand rear plate member with adhesive.

5. The adjustable mobile phone stand according to claim 4, the adhesive is part of double sided tape having the wax paper that may be removed from a first side one of the double sided tape to expose the adhesive and then a second side of the double sided tape is pressed onto the base plate member.
